(19) United States
(12) Patent Application Publication
(10) Pub. No.: US 2026/0261958 A1
(43) Pub. Date: Sep. 3, 2026

(54) SYSTEMS AND METHODS FOR RADIO ACCESS NETWORK BASED USER EQUIPMENT LOCATION VERIFICATION

(71) Applicant: APPLE INC., Cupertino, CA (US)

(72) Inventors: Fangli Xu, Beijing (CN); Peng Cheng, Beijing (CN); Yuqin Chen, Beijing (CN); Haijing Hu, Los Gatos, CA (US); Ralf Rossbach, Munich (DE); Ping-Heng Kuo, London (GB); Alexander Sirotkin, Hod Hasharon (IL); Naveen Kumar R Palle Venkata, San Diego, CA (US)

(21) Appl. No.: 18/878,700

(22) PCT Filed: Jul. 20, 2023
(86) PCT No.: PCT/US2023/070603

§ 371 Date: Dec. 24, 2024

Related U.S. Application Data
(60) Provisional application No. 63/369,823, filed on Jul. 29, 2022.

(51) Int. Cl. H04W 48/04; H04W 64/00; H04W 84/06

(52) U.S. Cl. CPC H04W 48/04; H04W 64/00; H04W 84/06

(57) ABSTRACT

Systems and methods for radio access network (RAN)-based user equipment (UE) location verification mechanisms are discussed herein. These may be used to verify a UE's report that it is in a geographical area served by a non-terrestrial network (NTN) cell that has a given set of applicable regulations, charging schemes, content access rules, etc. (e.g., that may be different than those for another geographical area covered by the same NTN cell). In embodiments, the base station may determine that the UE is not located in the reported geographical area based on: a failure to receive a response to a radio resource control (RRC) configuration message, scheduling information message, and/or paging on a beam of the NTN cell associated with the reported geographical area, and/or a determination that a preferred beam indicated by a measurement report from the UE does not correspond to a beam for the reported geographical area.

### TECHNICAL FIELD

This application relates generally to wireless communication systems, including wireless communication systems implementing non-terrestrial network (NTN) communication mechanisms.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR 2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an NTN architecture of a wireless communication system, according to an embodiment.

FIG. 2 illustrates a diagram of an NTN architecture according to an embodiment.

FIG. 3 illustrates a diagram of an NTN architecture according to an embodiment.

FIG. 4 illustrates a diagram of an NTN architecture according to an embodiment.

FIG. 5 illustrates a flow diagram for a RAN-based UE location verification framework, according to embodiments herein.

FIG. 6A illustrates a flow diagram showing an example use of a RAN-based UE location verification mechanism, according to an embodiment.

FIG. 6B illustrates a diagram corresponding to an example use of a RAN-based UE location verification mechanism, according to an embodiment.

FIG. 7 illustrates a method of a base station, according to an embodiment.

FIG. 8 illustrates a flow diagram showing an example use of a RAN-based UE location verification mechanism, according to an embodiment.

FIG. 9 illustrates a flow diagram showing an example use of a RAN-based UE location verification mechanism, according to an embodiment.

FIG. 10 illustrates a method of a base station, according to an embodiment.

FIG. 11 illustrates a method of a UE, according to an embodiment.

FIG. 12 illustrates a flow diagram showing an example use of a RAN-based UE location verification mechanism, according to an embodiment.

FIG. 13 illustrates a method of a base station, according to an embodiment.

FIG. 14 illustrates an example architecture of a wireless communication system, according to embodiments disclosed herein.

FIG. 15 illustrates a system for performing signaling between a wireless device and a RAN device connected to a core network of a CN device, according to embodiments herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Non-terrestrial networks (NTNs) refer to networks (or segments of networks) using airborne and/or space-borne vehicle(s) to perform communications.

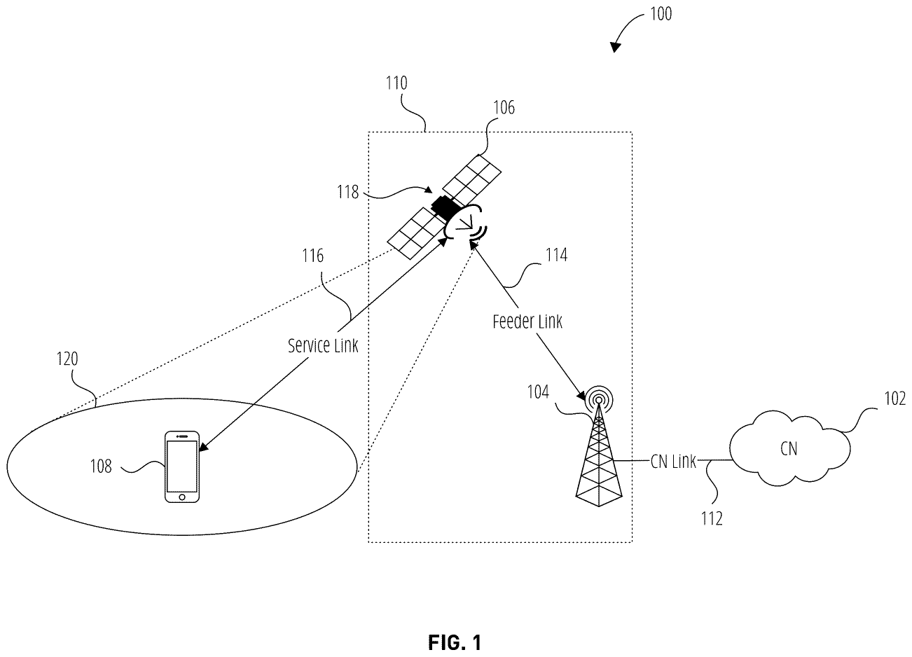

FIG. 1 illustrates an NTN architecture 100 of a wireless communication system, according to an embodiment. The NTN architecture 100 includes a core network (CN) 102, a base station 104, a vehicle 106 having a payload 118, and a UE 108. The base station 104, and the payload 118 of the vehicle 106 may be included in a RAN 110.

In some embodiments, RAN 110 includes NG-RAN, the CN 102 includes a 5GC, and the base station 104 includes a gNB or a next generation eNB (ng-eNB). In such cases, the CN link 112 connecting the CN 102 and the base station 104 may include an NG interface.

In the NTN architecture 100, the payload 118 of the vehicle 106 is a network node of the RAN 110. The payload 118 may be equipped with one or more antennas capable of operating (e.g., broadcasting, facilitating communications of, etc.) a cell 120 of the RAN 110 as instructed/configured by the base station 104. The base station 104 communicates (e.g., via a non-terrestrial gateway (not shown)) with the payload 118 of the vehicle 106 over a feeder link 114. The UE 108 may be equipped with one or more antennas (e.g., a moving parabolic antenna, an omni-directional phased-array antenna, etc.) capable of communicating with the payload 118 via a Uu interface on a cell 120 of the RAN over a service link 116. Herein cells (such as the cell 120) that are provided by a payload of an NTN vehicle may be referred to as “NTN cells.” It is also noted that a payload of an NTN may be sometimes referred to herein as an “NTN payload.”

The NTN architecture 100 illustrates a “bent-pipe” or “transparent” satellite based architecture. In such systems, the payload 118 transparently forwards data between the base station 104 and the UE 108 using the feeder link 114 between the base station 104 and the payload 118 and the service link 116 between the payload 118 and the UE 108. The payload 118 may perform radio frequency (RF) conversion and/or amplification in both uplink (UL) and downlink (DL) to enable this communication.

In the embodiment shown in FIG. 1, the base station 104 is illustrated without the (express) capability of terrestrial wireless communication directly with a UE. However, it is contemplated that in embodiments, such a base station using a non-terrestrial gateway to communicate with the payload 118 could (also) have this functionality (either with the UE 108 or with another (unillustrated) UE).

The NTN architecture 100 illustrates a vehicle 106 that is a space-borne satellite. In such cases, it may be that the vehicle 106 is a low earth orbit (LEO) satellite, a medium earth orbit (MEO) satellite, a geosynchronous earth orbit (GEO) satellite, or a high earth orbit (HEO) satellite. It is also noted that vehicles other than satellites may be used in NTN networks. For example, the vehicle 106 could instead be a high altitude platform station (HAPS) (such as, for example, an airship or an airplane).

In some cases, NTN networks may be useful to address mobile broadband needs and/or public safety needs in areas that are unserved/underserved by terrestrial-based network elements. Some such example cases include maritime applications, airplane connectivity applications, railway applications, etc.

It may be that in some cases an NTN network supports/uses, for example, LEOs and GEOs, with further implicit compatibility for supporting HAPSs and air-to-ground (ATG) scenarios. Further, an NTN network may focus on frequency division duplex (FDD) mechanisms, with time division duplex (TDD) mechanisms being applied for relevant scenarios, such as for HAPS, ATG, etc.

Some NTN networks may use earth-fixed tracking areas for defined areas that do not change corresponding to any movement of a payload of the NTN.

It may also be that UEs have the capability of determining their own location (e.g., via global navigation satellite systems (GNSSs) such as global positioning system (GPS), Galileo GNSS, etc.) and communicating that location information to the base station (e.g., via a payload).

UE that may be used in NTN networks may include, but are not limited to, handheld devices operating in FR1 (e.g., power class 3 devices) and/or very small aperture terminal (VSAT) devices with external antenna at least in FR2.

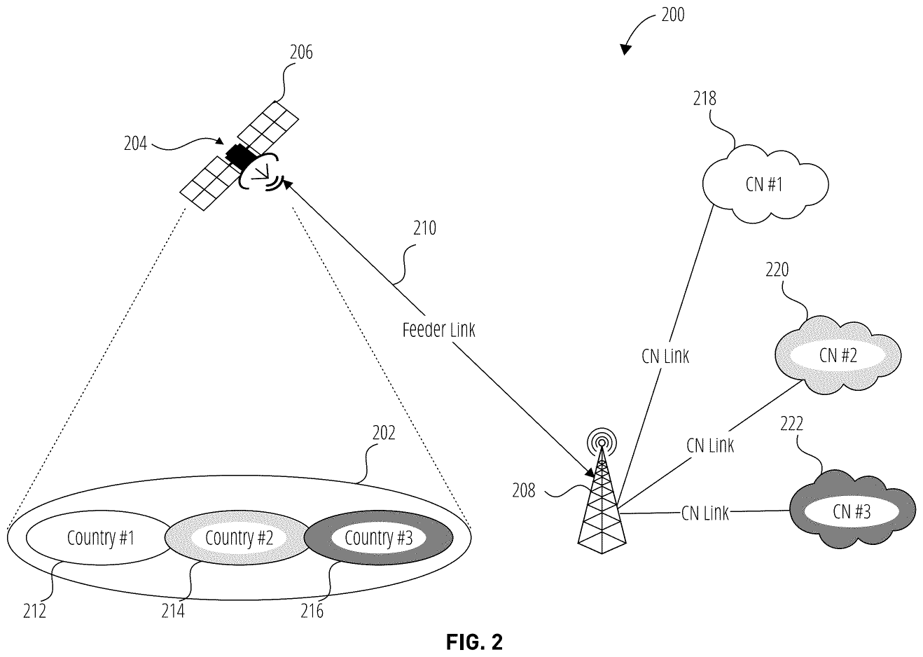

FIG. 2 illustrates a diagram 200 of an NTN architecture according to an embodiment. An NTN cell 202 (and/or a beam used within a cell) may cover a large area (e.g., due to the height of the payload 204 on the vehicle 206) relative to cell areas of cells/beams of cells broadcast by terrestrial-based equipment. For example, as illustrated, the NTN cell 202 covers multiple different geographical areas (including at least the country #1 212, the country #2 214, and the country #3 216).

An NTN may be able to broadcast multiple public land mobile networks (PLMNs) in a single cell, with one or more PLMNs corresponding individually to individual geographical areas within the cell. These PLMNs may be operated by individual CNs corresponding to each of the geographical areas. It is noted that examples herein may use different countries as the geographical areas that correspond to particular PLMNs/CNs. While this may reflect some real-world applications, it will be understood that other geographical areas (including, e.g., geographical areas not necessarily delineated along political boundaries) could exist within an NTN cell and be treated as described herein.

In the diagram 200 of FIG. 2, PLMN correspondence is illustrated with shading. Accordingly, it may be understood with reference to the diagram 200 that a first PLMN is operated by the first CN 218 for the country #1 212 via the base station 208 through the use of the feeder link 210, a second PLMN is operated by the second CN 220 for the country #2 214 via the base station 208 through the use of the feeder link 210, and a third PLMN is operated by the third CN 222 for the country #3 216 via the base station 208 through the use of the feeder link 210.

Multiple tracking area codes (TACs) per PLMN (up to, e.g., 12) may be used in a single NTN cell (such as the NTN cell 202). A UE communicating within the wireless communication system (e.g., according to the NTN architecture of the diagram 200) may not be expected to perform a registration procedure if one of the currently broadcast TACs belongs to the UE's present registration area.

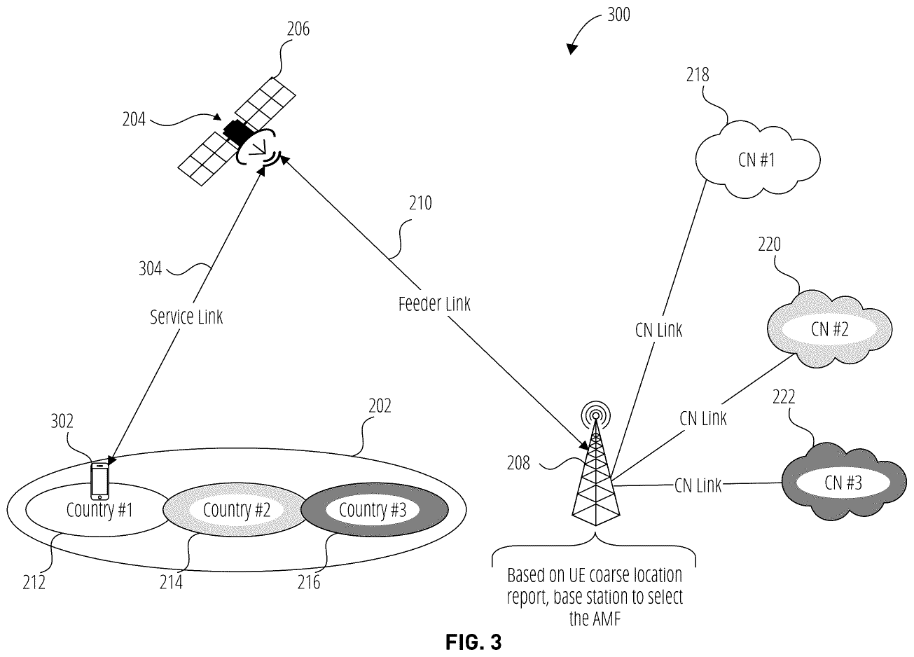

FIG. 3 illustrates a diagram 300 of an NTN architecture according to an embodiment. The diagram 300 may include elements of the diagram 200 as indicated, as these are described herein, with elements of the flow diagram 300 that remain analogous to similar elements of the diagram 200 being numbered again as in the diagram 200.

Further, the diagram 300 illustrates a UE 302 that is located in country #1 212 and that communicates with the base station 208 via signaling with the payload 204 of the vehicle 206 via a service link 304, as illustrated.

The UE 302 may provide a location report to the base station via the payload 204. For example, the UE may determine its own location in terms of GNSS coordinates, within an accuracy of, for example, around two kilometers (km) and report this value to the base station 208. This may be an example of a “coarse location report” as used herein.

Based on the location report, the base station 208 may perform access and mobility management function (AMF) selection (e.g., may select an AMF of one of the first CN 218, the second CN 220, and the third CN 222 to control access and/or mobility for the UE 302). In cases where the base station has been configured to ensure that the selected AMF serves the country where the UE is located, the base station will select the AMF of the CN that operates the PLMN for the country in which the UE is located. In the case of the diagram 300, this means that the base station 208 will select the AMF of the first CN 218 because the UE's location report identified the UE as being located in country #1 212, and access and/or mobility for the UE 302 will accordingly be managed by the AMF of the first CN 218.

It may be that the base station uses the reported location of the UE to select the AMF in this manner in order to comply with regulatory requirements (e.g., that ensure that the access of the UE is accurate, private, reliable, and of acceptable latency). Examples of regulated features where it may be important to ensure that the UE is connected to a CN (e.g., an AMF of the CN) that corresponds to is present location (in order to comply with the regulation) include, but are not limited to, cases where the UE makes an emergency call, cases where a lawful intercept of communications is to occur per the applicable law in the geographical area where the UE is located, cases where public warnings are to be issued to UEs in the geographical area where the UE is located, enforcement of data retention policies based on cross-border situations, and/or for accurate charging and billing based on the geographical area where the UE is located. Accordingly, development of systems and methods enabling a wireless communication system to locate UEs in a reliable manner such that corresponding policy that applies to their operation depending on their location and/or context may be accurately determined is beneficial.

To meet such regulatory requirements, an NTN network may enforce the correspondence between operation under a particular PLMN and the present location of the UE in a geographical area corresponding to that PLMN. This may be accomplished in at least some cases by causing the network to verify the location reported by the UE during mobility management and session management procedures.

Such verification is useful because it can be the case that a UE reported location (as nominally determined at the UE using, e.g., GNSS and then reported to the base station, as described) could be erroneous. For example, a user of the UE or a third party may maliciously configure the UE to report an incorrect location (with the purpose of, for example, being incorrectly assigned within the wireless communication system to a geographical area that, e.g., is licensed for certain content that is not licensed in the actual geographical area of the UE, has a cheaper charging and billing than that associated with the actual geographical area of the UE, etc.). As another example, interference may cause the UE reported location to be incorrect (e.g., the UE may incorrectly determine its location when GNSS signals have high interference).

Accordingly, systems and methods disclosed herein relate to manners in which the RAN can independently perform verification on the location report provided by the UE to the network, in order to ensure that the UE is associated with the correct CN-related features/functions (e.g., corresponding to the correct PLMN corresponding to an actual location of the UE), such as the AMF of the CN which controls access functions for the UE. Systems and methods disclosed herein may operate to perform this function in a manner that overcomes inherent difficulties that arise due to the large relative size of a single NTN cell and the corresponding potential of having multiple differently-treated geographical locations sited therein.

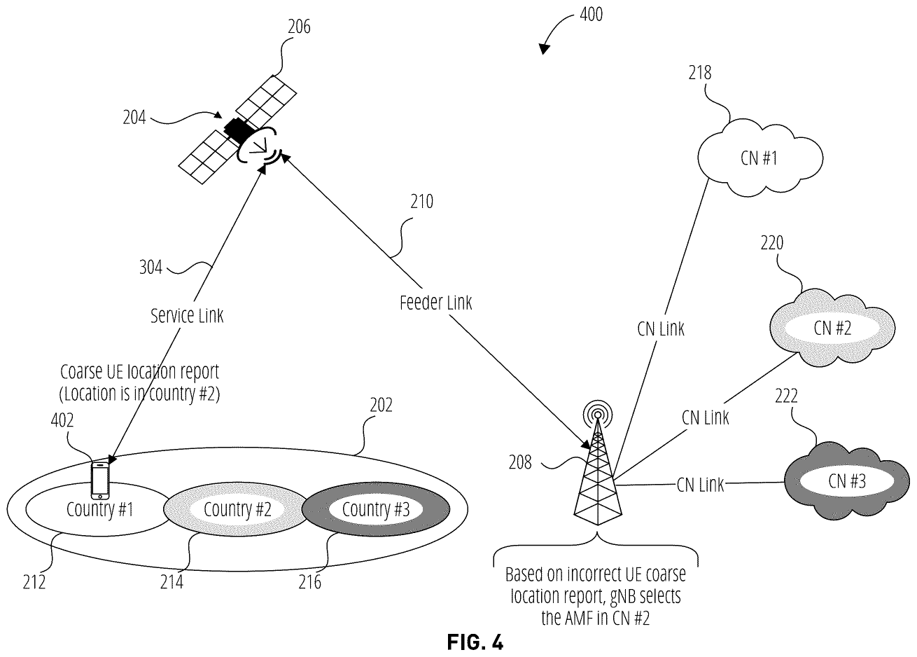

FIG. 4 illustrates a diagram 400 of an NTN architecture according to an embodiment. The diagram 400 may include elements of the diagram 200 as indicated, as these are described herein, with elements of the flow diagram 400 that remain analogous to similar elements of the diagram 200 being numbered again as in the diagram 200. The diagram 400 illustrates an example of a scenario involving a UE 402 that may occur in cases where a location reported by the UE 402 is not verified using a RAN-based UE location verification mechanism.

As may be seen, the UE 402 is presently located in the country #1 212. The UE 402 may send, to the base station 208, via the payload 204, a location report that inaccurately indicates that the reported location of the UE is in country #2 214. In response, the base station 208 selects the second CN 220/the AMF in second CN 220 corresponding to country #2 214 to provide service to the UE 402. Among other issues, this allows the UE 402 to acquire information specific to country #2 214 via the NTN connection (e.g., public warning system (PWS) information for country #2 214, media content licensed for the country #2 214, etc.), to be operated according to the charging policy of country #2 214, etc., outside of any national regulations and/or other operational constraints which should apply to the use of the UE 402 in the country #1 212.

It may be that a base station is pre-configured with a mapping between a geographical area as identified in the wireless communication system (e.g., a country) and the corresponding real geographical area within the NTN cell. The base station then identifies the geographical area (e.g., country) within which the UE is present within the NTN cell according to a location report (e.g., a coarse location report) from the UE, in the manner that has been described.

Then, a RAN-based UE location verification framework may be established that enables the network to verify the UE-reported location. In some such cases, the RAN-based UE location verification framework may be enabled by the base station itself.

In some such cases, the RAN-based UE location verification framework may be enabled/triggered by a CN (e.g., an AMF in the CN). For example, an AMF of the CN may send, to the base station, a message that indicates that the RAN-based UE location verification is to be performed (e.g., a Location Reporting Control message). In some cases, this indication may be performed via the presence and/or a value of a VerificationRequest information element (IE) that is present in the message from the AMF to the base station.

In some such cases, the RAN-based location verification framework may be enabled by operations, administration and maintenance (OAM) operation and/or procedure of an operator of, e.g., the applicable base station.

A condition to enable the RAN-based UE location verification may be based on an event trigger, or may be preconfigured. In some cases, RAN-based UE location verification may be enabled for only some types of UEs, while in other cases it may be enabled for all UEs.

In cases where the base station identifies that the location reported by the UE is not reliable, the base station may report this information to a CN (e.g., to an AMF of the CN). In some cases, this indication may be performed via the presence and/or a value of a VerificationFailureInd IE or a Cause IE that is present in a message (e.g., a Location Reporting Failure Indication message) from the base station to an AMF of a CN.

Then, the base station and/or the CN may record the UE in a blacklist (e.g., based on UE equipment or based on user of the UE) and autonomously trigger RAN-based UE location verification for this UE/user for a next number N of accesses by that UE/user.

In some embodiments, if the base station can acquire accurate UE location information with a certain granularity (e.g., to the level of a country associated with a particular PLMN/CN), the base station may elect to simply ignore a location report by the UE and/or disable location reporting at the UE.

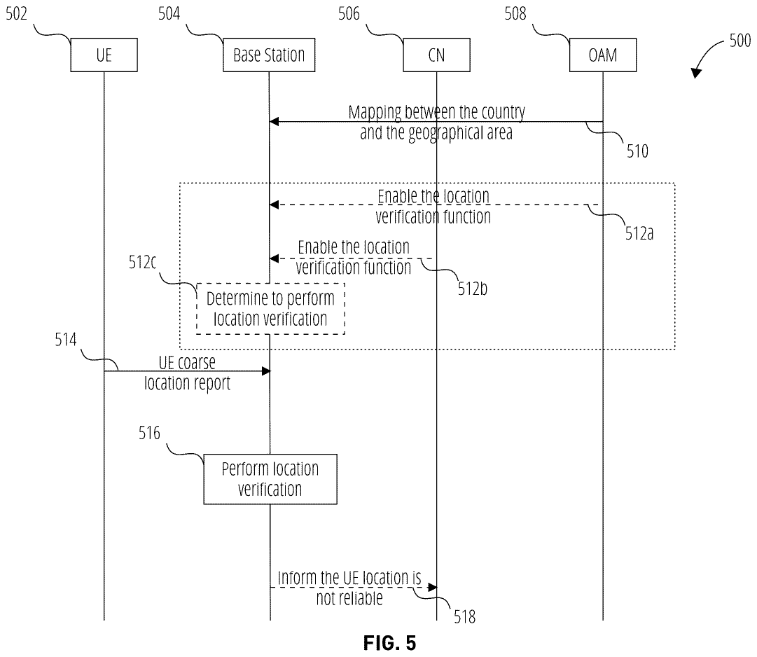

FIG. 5 illustrates a flow diagram 500 for a RAN-based UE location verification framework, according to embodiments herein. The flow diagram 500 shows communications between and operations of a UE 502, a base station 504, a CN 506, and an OAM operation 508.

The OAM operation 508 provides 510 the base station 504 with a mapping between a country that operates according to the wireless communication system and the actual geographical area within an NTN cell.

Then the OAM operation 508 (e.g., as performed by an operator of the base station) instructs 512a, the CN 506 instructs 512b the base station 504, or the base station 504 autonomously determines 512c to enable a RAN-based UE location verification function.

The UE 502 provides the base station 504 (e.g., via an NTN payload operating a serving cell of the base station) with a UE location report (e.g., a UE coarse location report, as illustrated) that reports the UE location to the base station 504.

The base station 504 then performs 516 location verification for the UE based on the UE-reported location received in the UE location report. Particular methods for how this may be performed are discussed elsewhere herein.

In some embodiments, in the event that the base station 504 determines that the UE's reported location is not reliable based on location verification, the base station 504 informs 518 the CN 506 that the UE's reported location is not reliable.

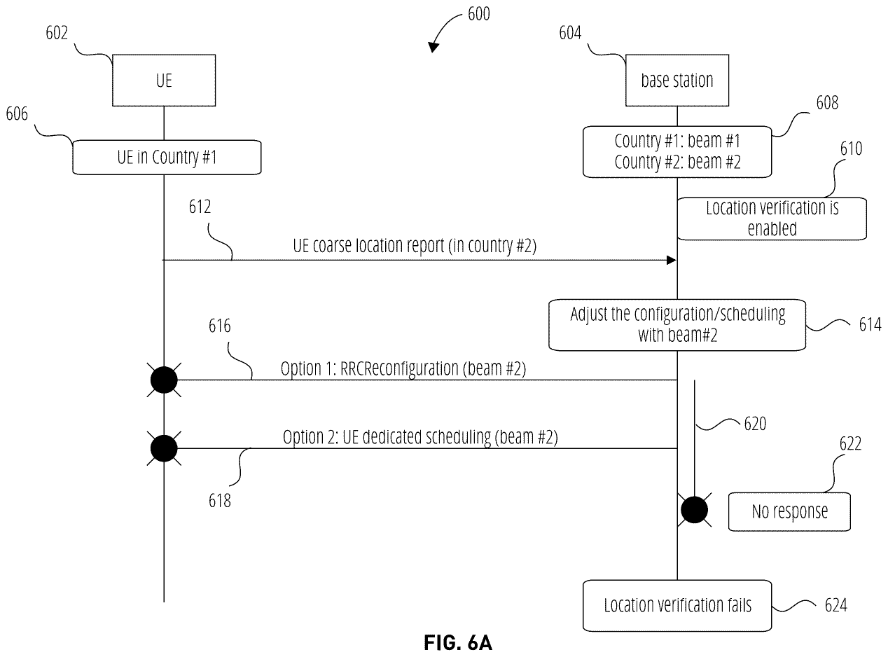

FIG. 6A illustrates a flow diagram 600 showing an example use of a RAN-based UE location verification mechanism, according to an embodiment. FIG. 6B illustrates a diagram 626 corresponding to an example use of a RAN-based UE location verification mechanism, according to an embodiment. The diagram 626 of FIG. 6B corresponds to the flow diagram 600 of FIG. 6A, and thus the flow diagram 600 and the diagram 626 will be discussed together.

The flow diagram 600 illustrates the signaling between and operations of a UE 602 and a base station 604. As indicated 606, the UE 602 is actually physically present within country #1 630 within the NTN cell 628.

Further, as indicated 608, there may be a correspondence known to the base station 604 between countries/geographical areas served by the NTN cell and particular beams used by the NTN payload to communicate with UE in those countries/geographical areas. For example, as illustrated, the NTN payload may use a first beam (“beam #1”) to perform communications with UE in country #1 630 and a second beam (“beam #2”) to perform communications with UE in country #2 632. In such cases, each individual beam may be formed/directed/shaped (e.g., by the NTN payload) such that it works well for communications with the physical geographical areas of its corresponding country, and such that it does not work well (or at all) for communications with other countries within the cell.

As illustrated, RAN-based UE location verification is enabled 610 at the base station 604. This may be due to an autonomous decision by the base station 604. Alternatively, it may be responsive to an instruction by a CN to the base station 604. Alternatively, it may be responsive to an instruction at the base station 604 as a result of an OAM operation performed by an operator of the base station 604.

The UE provides 612 the base station 604 (e.g., via communication with an NTN payload 634 of the base station 604 on the vehicle 636) with a UE location report (e.g., a coarse UE location report, as illustrated) that reports the UE location to the base station 604. As illustrated, the UE location report indicates that the UE is present country #2 632.

Based on the UE reported location within country #2 632, the UE determines that beam #2 (that corresponds to the country #2 632) is an appropriate beam to use to communicate further with the UE. Accordingly, the base station adjusts 614 a configuration and/or a scheduling of the UE by sending an appropriate message on beam #2. For example, in a first option, the base station 604 sends 616 a radio resource control (RRC) message (e.g., an RRCReconfiguration message) to the UE 602 on beam #2. In a second option, the base station 604 sends 618 a scheduling information message (e.g., a UE dedicated scheduling message) to the UE 602 on beam #2.

However, because the UE 602 is not actually present in the country #2 632 corresponding to beam #2, this communication will fail (either because it was not ever received at the UE 602, or because the UE's position in country #1 630 means that any response sent by the UE is not receivable at the payload 634 corresponding to the use of beam #2 at the payload 634). Accordingly, the flow diagram 600 illustrates that after a time window 620, the base station 604 determines 622 that it has not received an appropriate response to the prior messaging.

Based on the failure to receive the expected responsive messaging from the UE 602, the base station may assume that the UE 602 is not actually in the geographical area corresponding to the country #2 632 as reported. Accordingly, the base station 604 determines 624 that the location of the UE 602 as reported by the UE 602 is not verified.

The base station 604 may then proceed to restrict an operation of the UE 602 with a network service for country #2 632 based on the determination that the UE 602 is not located in country #2 632 as indicated by the reported location. For example, it may be that the UE 602 is not permitted to perform some types of/any user plane communications on the network that would require that and/or that are otherwise based on an understanding that the UE is in country #2 632 unless and until the UE 602 later reports a verifiable location in country #2 632. This restriction may include rejecting an attempted connection by the UE 602 with a CN/AMF of country #2 632.

Relating back to the flow diagram 500 of FIG. 5, it may be understood that the operation 612 of the flow diagram 600 corresponds to the operation 514 of the flow diagram 500, and that the operations 614 through 624 of the flow diagram 600 correspond to the operation 516 of the flow diagram 500.

In some embodiments, as discussed relative to the operation 518 in the flow diagram 500, the base station 604 may further proceed to indicate to a CN that the UE 602 is not located in the country/geographical area indicated by the UE's location report.

In some embodiments, the base station 604 may itself log that the UE is not located in the country/geographical area indicated by the UE's location report.

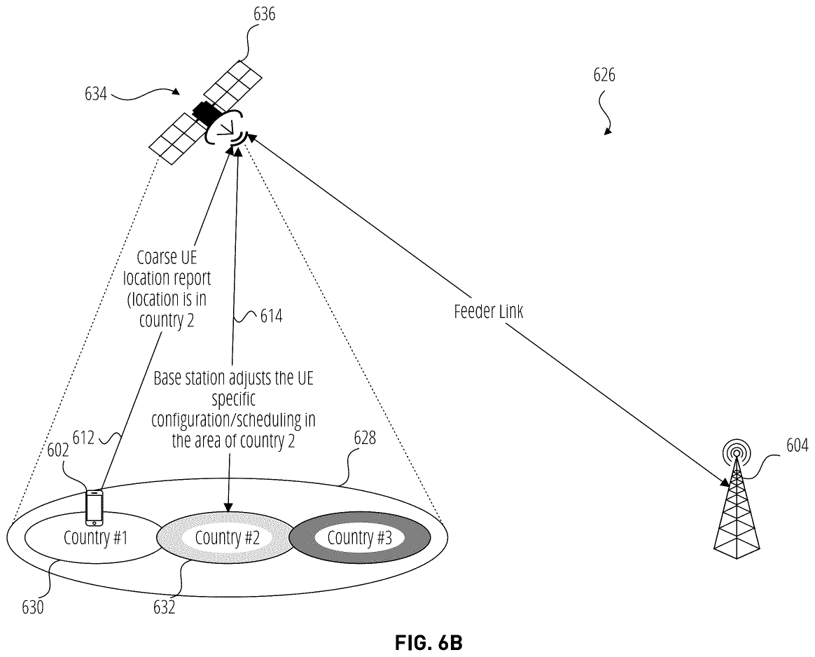

FIG. 7 illustrates a method 700 of a base station, according to an embodiment. The method 700 includes receiving 702, from a UE, via an NTN payload operating a serving cell of the base station, a reported location indicating that the UE is located in a geographical area of the serving cell corresponding to a beam used by the NTN payload.

The method 700 further includes performing 704 verification on the reported location by sending, to the UE, via the NTN payload, one of an RRC configuration message and a scheduling information message on the beam and determining, based on a failure to receive a response from the UE to the one of the RRC configuration message and the scheduling information message, that the UE is not located in the geographical area as indicated by the reported location.

The method 700 further includes restricting 706 an operation of the UE with a network service for the geographical area based on the determination that the UE is not located in the geographical area.

In some embodiments, the method 700 further includes indicating, to a CN, that the UE is not located in the geographical area.

In some embodiments, the method 700 further includes logging, at the base station, that the UE is not located in the geographical area.

In some embodiments, the method 700 further includes receiving an instruction to perform the verification on the reported location. In some such embodiments, the instruction is received from a CN. In some such embodiments, the instruction is received as part of an OAM procedure performed by an operator of the base station.

In some embodiments of the method 700, the verification is performed on the reported location in response to a detection of a triggering event.

In some embodiments of the method 700, the verification is performed on the reported location in response to a determination that the UE is of a type for which the verification on the reported location is to be performed.

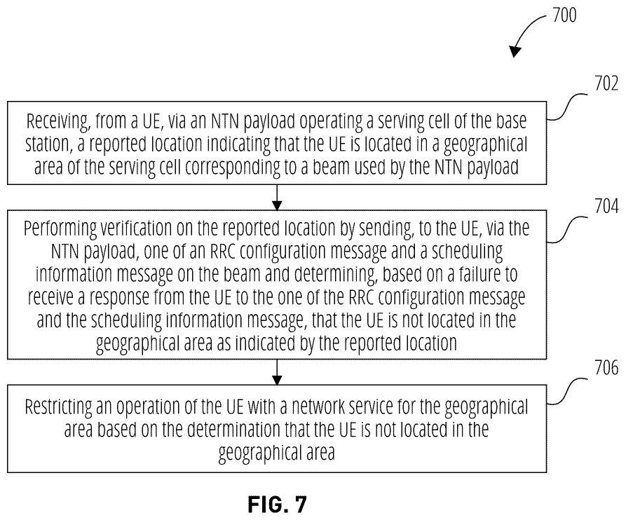

FIG. 8 illustrates a flow diagram 800 showing an example use of a RAN-based UE location verification mechanism, according to an embodiment. The flow diagram 800 illustrates the signaling between a UE 802 and a base station 804. As indicated 806, the UE is actually physically present in a first country (“country #1”).

Further, as indicated 808, there may be a correspondence known to the base station 804 between countries/geographical areas served by the NTN cell and particular beams used by the NTN payload to communicate with UE in those countries/geographical areas. For example, as illustrated, the NTN payload may use a first beam (“beam #1”) to perform communications with UE in country #1 and a second beam (“beam #2”) to perform communications with UE in a second country (“country #2”). In such cases, each individual beam may be formed/directed/shaped (e.g., by the NTN payload) such that it works well for communications with the physical geographical areas of its corresponding country, and such that it does not work well (or at all) for communications with other countries within the cell.

As illustrated, RAN-based UE location verification is enabled 810 at the base station 804. This may be due to an autonomous decision by the base station 804. Alternatively, it may be responsive to an instruction by a CN to the base station 804. Alternatively, it may be responsive to an instruction at the base station 804as a result of an OAM operation performed by an operator of the base station 804.

The UE provides 812 the base station 804 (e.g., via communication with an NTN payload of the base station 804) with a UE location report (e.g., a coarse UE location report, as illustrated) that reports the UE location to the base station 804. As illustrated, the UE location report indicates that the UE is present country #2.

The UE also provides 814 the base station 804 with a measurement report (e.g., a layer 1 (L1) channel state information (CSI) report and/or a layer 3 (L3) beam measurement report, as illustrated) that indicates that a preferred beam of the NTN payload for the UE is beam #1. For example, an L3 beam measurement report may indicate strong measurements of DL Rx beams at the UE that are understood by the base station 804 to correspond to beam #1 rather than beam #2. As another example, an L1 CSI report may report a channel corresponding to beam #1 is a better channel than a channel corresponding to beam #2.

In response, the base station 804 determines 816 that the country corresponding to the UE location report and the preferred beam on the NTN payload (e.g., as indicated by/derived from the received measurement report) for the UE are mismatched. In other words, the base station 804 determines that the preferred beam on the NTN payload does not correspond to the country/geographical area corresponding to the location of the UE as reported by the UE.

Based on the existence of this mismatch, the base station 804 may assume that the UE 802 is not in the actual geographical area corresponding to country #2 as reported. Accordingly, the base station 804 determines 818 that the location of the UE 802 as reported by the UE 802 is not verified.

The base station 804 may then proceed to restrict an operation of the UE 802 with a network service for country #2 based on the determination that the UE 802 is not located in country #2 as indicated by the reported location. For example, it may be that the UE 802 is not permitted to perform some types of/any user plane communications on the network that would require that and/or that are otherwise based on an understanding that a UE is in country #2 unless and until the UE 802 later reports a verifiable location in country #2. This restriction may include rejecting an attempted connection by the UE 802 with a CN/AMF of country #2.

Relating back to the flow diagram 500 of FIG. 5, it may be understood that the operation 812 of the flow diagram 800 corresponds to the operation 514 of the flow diagram 500, and that the operations 814 through 818 of the flow diagram 800 correspond to the operation 516 of the flow diagram 500.

In some embodiments, as discussed relative to the operation 518 in the flow diagram 500, the base station 804 may further proceed to indicate to a CN that the UE 802 is not in located in the country/geographical area indicated by the UE's location report.

In some embodiments, the base station 804 may itself log that the UE is not located in the country/geographical area indicated by the UE's location report.

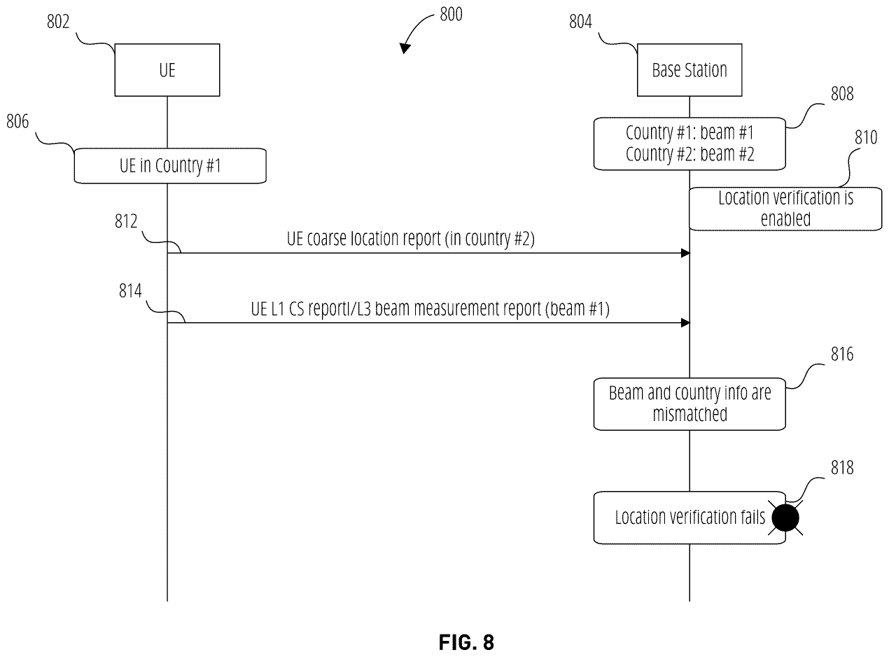

FIG. 9 illustrates a flow diagram 900 showing an example use of a RAN-based UE location verification mechanism, according to an embodiment. The flow diagram 900 represents an adjusted version of the flow diagram 800, with elements of the flow diagram 900 that remain analogous to similar elements of the flow diagram 800 being numbered again as in the flow diagram 800.

Differently from the flow diagram 800, in the flow diagram 900, prior to the receipt of a UE location report, the base station 804 sends 902 a location reporting request (e.g., an enhanced UE coarse location request, as illustrated) to the UE. This location reporting request may indicate that a reported location of the UE and a measurement report are to be provided to the base station 804 jointly. In response to this location reporting request, the UE 802 jointly sends 904 both a UE location report (e.g., a UE coarse location report) that reports the location of the UE and a measurement report (e.g., containing one or more of an L1 CSI report and/or an L3 beam measurement report, as was described in relation to the flow diagram 800 of FIG. 8) to the base station 804.

The base station 804 may then use the reported location of the UE and the measurement report to determine whether there is a mismatch between a beam for the reported location of the UE and a preferred beam corresponding to the information found in the measurement report, in the manner described in relation to FIG. 8.

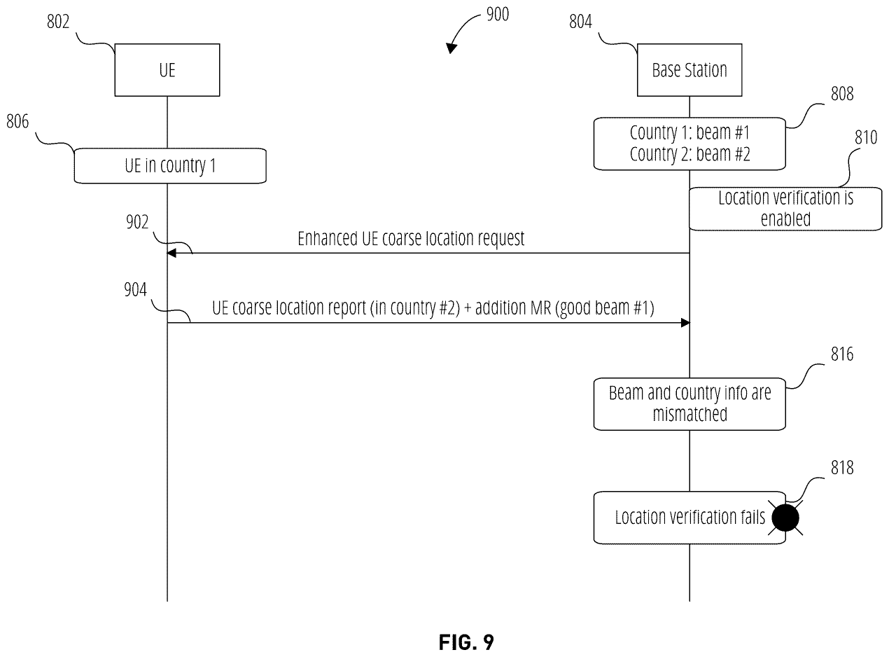

FIG. 10 illustrates a method 1000 of a base station, according to an embodiment. The method 1000 includes receiving 1002, from a UE, via an NTN payload operating a serving cell of the base station, a reported location indicating that the UE is located in a geographical area of the serving cell.

The method 1000 further includes performing 1004 verification on the reported location by receiving, from the UE, via the NTN payload, a measurement report indicating a preferred beam of the NTN payload for the UE, wherein the preferred beam does not correspond to the geographical area and determining, based on a determination that the preferred beam does not correspond to the geographical area, that the UE is not located in the geographical area.

The method 1000 further includes restricting 1006 an operation of the UE with a network service for the geographical area based on the determination that the UE is not located in the geographical area as indicated by the reported location.

In some embodiments, the method 1000 further comprises sending, to the UE, via the NTN payload, a location reporting request indicating that the reported location and the beam report be sent jointly by the UE, and wherein the reported location and the beam report are received jointly at the base station in response to the location reporting request.

In some embodiments, the method 1000 further comprises indicating, to a CN, that the UE is not located in the geographical area.

In some embodiments, the method 1000 further comprises logging, at the base station, that the UE is not located in the geographical area.

In some embodiments, the method 1000 further comprises receiving an instruction to perform the verification on the reported location. In some such embodiments, the instruction is received from a CN. In some such embodiments, the instruction is received as part of an OAM procedure performed by an operator of the base station.

In some embodiments of the method 1000, the verification is performed on the reported location in response to a detection of a triggering event.

In some embodiments of the method 1000, the verification is performed on the reported location in response to a determination that the UE is of a type for which the verification on the reported location is to be performed.

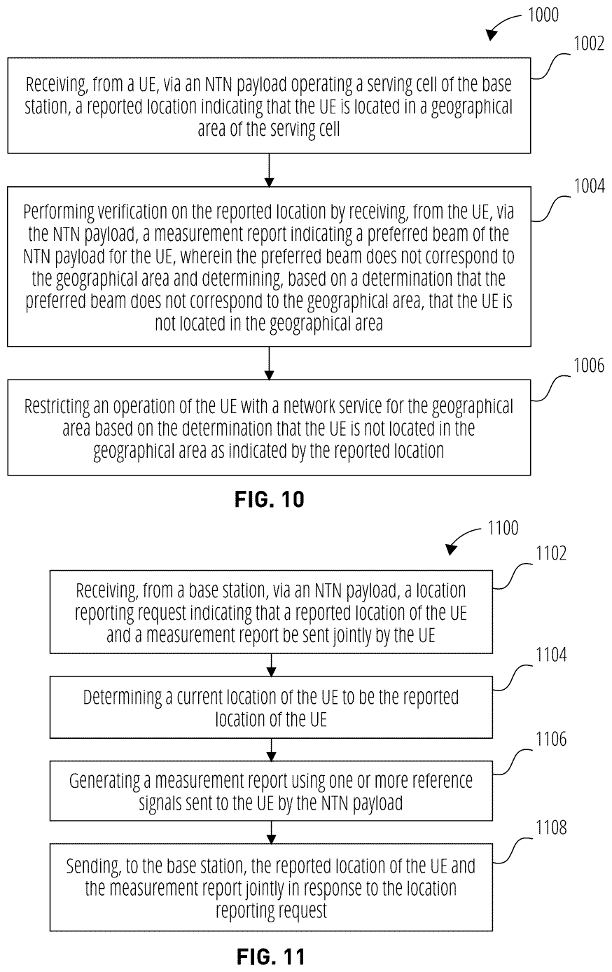

FIG. 11 illustrates a method 1100 of a UE, according to an embodiment. The method 1100 includes receiving 1102, from a base station, via an NTN payload, a location reporting request indicating that a reported location of the UE and a measurement report be sent jointly by the UE.

The method 1100 further includes determining 1104 a current location of the UE to be the reported location of the UE.

The method 1100 further includes generating 1106 a measurement report using one or more reference signals sent to the UE by the NTN payload.

The method 1100 further includes sending 1108, to the base station, the reported location of the UE and the measurement report jointly in response to the location reporting request.

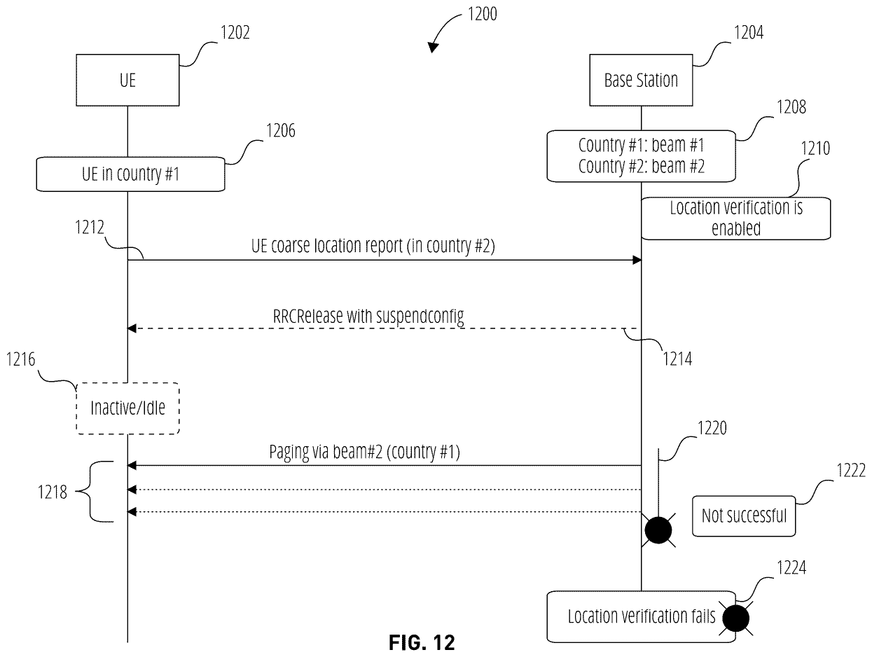

FIG. 12 illustrates a flow diagram 1200 showing an example use of a RAN-based UE location verification mechanism, according to an embodiment. The flow diagram 1200 illustrates the signaling between a UE 1202 and a base station 1204. As indicated 1206, the UE is actually physically present in a first country (“country #1”).

Further, as indicated 1208, there is a correspondence known to the base station 1204 between countries/geographical areas served by the NTN cell and particular beams used by the NTN payload to communicate with UE in those countries/geographical areas. For example, as illustrated, the NTN payload may use a first beam (“beam #1”) to perform communications with UE in country #1 and a second beam (“beam #2”) to perform communications with UE in a second country (“country #2”). In such cases, each individual beam may be formed/directed/shaped (e.g., by the NTN payload) such that it works well for communications with the physical geographical areas of its corresponding country, and such that it does not work well (or at all) for communications with other countries areas within the cell.

As illustrated, RAN-based UE location verification is enabled 1210 at the base station 1204. This may be due to an autonomous decision by the base station 1204. Alternatively, it may be responsive to an instruction by a CN to the base station 1204. Alternatively, it may be responsive to an instruction at the base station 1204 as a result of an OAM operation performed by an operator of the base station 1204.

The UE provides 1212 the base station 1204 (e.g., via communication with an NTN payload of the base station 1204) with a UE location report (e.g., a coarse UE location report, as illustrated) that reports the UE location to the base station 1204. As illustrated, the UE location report indicates that the UE is in present country #2.

The base station 1204 then (optionally) provides 1214 the UE 1202 with an RRC release message (e.g., via the illustrated RRCRelease message with a suspendconfig parameter). In response, if the UE 1202 is in an RRC connected mode with the base station 1204, the UE transitions 1216 out of the RRC connected mode and into an RRC inactive or an RRC idle mode.

The base station 1204 then subsequently sends paging 1218 to the UE 1202 (with the paging 1218 optionally including multiple individual pages occurring during a time window 1220, as illustrated). Based on the UE reported location within country #2, the base station 1204 determines that beam #2 (that corresponds to country #2) is an appropriate beam to use to communicate with the UE. Accordingly, as illustrated, the base station 1204 performs the paging 1218 on beam #2. It is contemplated that in embodiments where the base station 1204 does not provide 1214 the RRC release message previously discussed, this paging will be understood to be directed to the UE 1202 while the UE 1202 may be in an RRC connected mode with the base station 1204.

Because the UE 1202 is not actually present in country #2 corresponding to beam #2, no response (e.g., responsive messaging attempting to trigger and/or confirm an RRC connected mode of the UE 1202 with the base station 1204) to the paging 1218 will be received at the base station 1204 (either because the paging 1218 was not ever received at the UE 1202, or because the UE's position in country #2 means that any response sent by the UE is not receivable at the payload corresponding to the use of beam #2 at the payload). Accordingly, the flow diagram 1200 illustrates that after the time window 1220, the base station 1204 determines 1222 that it has not been successful in delivering the paging 1218 to the UE 1202.

Based on the failure to receive the expected responsive messaging from the UE 1202, the base station 1204 assumes that the UE 1202 is not actually in the geographical area corresponding to country #2 as reported. Accordingly, the base station 1204 determines 1224 that the location of the UE 1202 as reported by the UE 1202 is not verified.

The base station 1204 may then proceed to restrict an operation of the UE 1202 with a network service for country #2 based on the determination that the UE 1202 is not located in country #2 as indicated by the reported location. For example, it may be that the UE 1202 is not permitted to perform some types of/any user plane communications on the network that would require that and/or that are otherwise based on an understanding that a UE is in country #2 unless and until the UE 1202 later reports a verifiable location in country #2. This restriction may include rejecting an attempted connection by the UE 1202 with a CN/AMF of country #2.

Relating back to the flow diagram 500 of FIG. 5, it may be understood that the operation 1212 of the flow diagram 1200 corresponds to the operation 514 of the flow diagram 500, and that the operations 1214 through 1224 of the flow diagram 1200 correspond to the operation 516 of the flow diagram 500.

In some embodiments, as discussed relative to the operation 518 in the flow diagram 500, the base station 1204 may further proceed to indicate to a CN that the UE 1202 is not in located in the country/geographical area indicated by the UE's location report.

In some embodiments, the base station 1204 may itself log that the UE is not located in the country/geographical area indicated by the UE's location report.

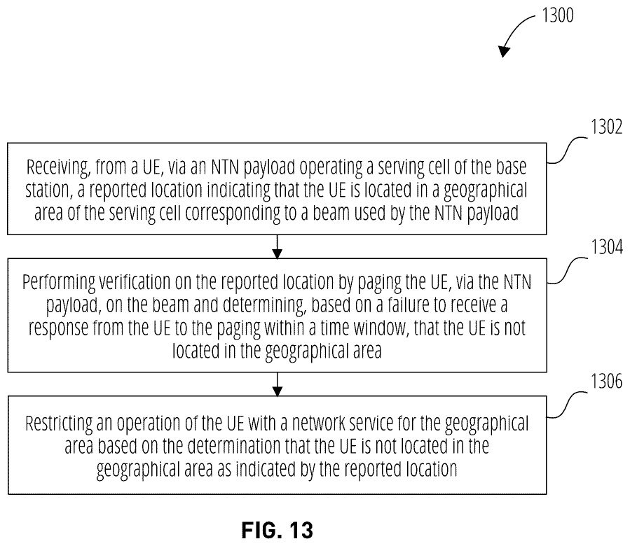

FIG. 13 illustrates a method 1300 of a base station, according to an embodiment. The method 1300 includes receiving 1302, from a UE, via an NTN payload operating a serving cell of the base station, a reported location indicating that the UE is located in a geographical area of the serving cell corresponding to a beam used by the NTN payload.

The method 1300 further includes performing 1304 verification on the reported location by paging the UE, via the NTN payload, on the beam and determining, based on a failure to receive a response from the UE to the paging within a time window, that the UE is not located in the geographical area.

The method 1300 further includes restricting 1306 an operation of the UE with a network service for the geographical area based on the determination that the UE is not located in the geographical area as indicated by the reported location.

In some embodiments, the method 1300 further includes sending, to the UE, via the NTN payload, a RRC release message to cause the UE to transition out of an RRC connected mode prior to performing the paging.

In some embodiments, the method 1300 further includes indicating, to a CN, that the UE is not located in the geographical area.

In some embodiments, the method 1300 further includes logging, at the base station, that the UE is not located in the geographical area.

In some embodiments, the method 1300 further includes receiving an instruction to perform the verification on the reported location. In some such embodiments, the instruction is received from a CN. In some such embodiments, the instruction is received as part of an OAM procedure performed by an operator of the base station.

In some embodiments of the method 1300, the verification is performed on the reported location in response to a detection of a triggering event.

In some embodiments of the method 1300, the verification is performed on the reported location in response to a determination that the UE is of a type for which the verification on the reported location is to be performed.

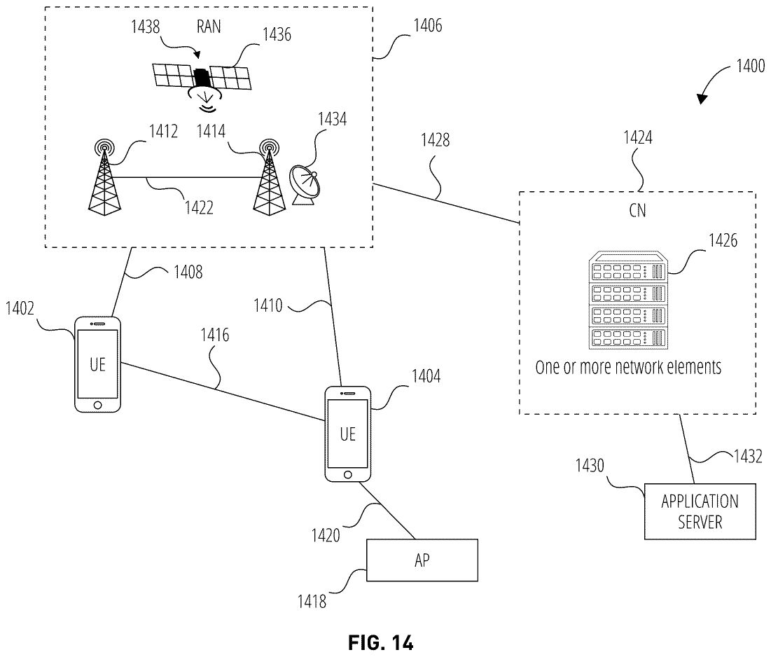

FIG. 14 illustrates an example architecture of a wireless communication system 1400, according to embodiments disclosed herein. The following description is provided for an example wireless communication system 1400 that operates in conjunction with the LTE system standards and/or 5G or NR system standards as provided by 3GPP technical specifications and other 3GPP documents.

As shown by FIG. 14, the wireless communication system 1400 includes UE 1402 and UE 1404 (although any number of UEs may be used). In this example, the UE 1402 and the UE 1404 are illustrated as smartphones (e.g., handheld touchscreen mobile computing devices connectable to one or more cellular networks), but may also comprise any mobile or non-mobile computing device configured for wireless communication.

The UE 1402 and UE 1404 may be configured to communicatively couple with a RAN 1406. In embodiments, the RAN 1406 may be NG-RAN, E-UTRAN, etc. The UE 1402 and UE 1404 utilize connections (or channels) (shown as connection 1408 and connection 1410, respectively) with the RAN 1406, each of which comprises a physical communications interface. The RAN 1406 can include one or more base stations (such as base station 1412 and the base station 1414) and/or other entities (e.g., a payload on the satellite 1436, which may operate a cell as directed by one of the base station 1412 and/or the base station 1414) that enable the connection 1408 and connection 1410. One or more non-terrestrial gateways 1434 may integrate the payload 1438 on the satellite 1436 into the RAN 1406, in the manner described in relation to the NTN architecture 100 of FIG. 1.

In this example, the connection 1408 and connection 1410 are air interfaces to enable such communicative coupling, and may be consistent with RAT(s) used by the RAN 1406, such as, for example, an LTE and/or NR. It is contemplated that the connection 1408 and connection 1410 may include, in some embodiments, service links between their respective UE 1402, UE 1404 and the payload 1438 of the satellite 1436.

In some embodiments, the UE 1402 and UE 1404 may also directly exchange communication data via a sidelink interface 1416.

The UE 1404 is shown to be configured to access an access point (AP) (shown as AP 1418) via connection 1420. By way of example, the connection 1420 can comprise a local wireless connection, such as a connection consistent with any IEEE 802.11 protocol, wherein the AP 1418 may comprise a Wi-Fi® router. In this example, the AP 1418 may be connected to another network (for example, the Internet) without going through a CN 1424.

In embodiments, the UE 1402 and UE 1404 can be configured to communicate using orthogonal frequency division multiplexing (OFDM) communication signals with each other, with the base station 1412, the base station 1414, and/or the payload 1438 of the satellite 1436 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1412 and/or the base station 1414 may be implemented as one or more software entities running on server computers as part of a virtual network.

In addition, or in other embodiments, the base station 1412 or base station 1414 may be configured to communicate with one another via interface 1422. In embodiments where the wireless communication system 1400 is an LTE system (e.g., when the CN 1424 is an EPC), the interface 1422 may be an X2 interface. The X2 interface may be defined between two or more base stations (e.g., two or more eNBs and the like) that connect to an EPC, and/or between two eNBs connecting to the EPC. It is contemplated than an inter-satellite link (ISL) may carry the X2 interface between in the case of two satellite base stations.

In embodiments where the wireless communication system 1400 is an NR system (e.g., when CN 1424 is a 5GC), the interface 1422 may be an Xn interface. An Xn interface is defined between two or more base stations that connect to 5GC (e.g., CN 1424). For example, the Xn interface may be between two or more gNBs that connect to 5GC, a gNB connecting to 5GC and an eNB, between two eNBs connecting to 5GC.

In embodiments where the wireless communication system 1400 is an LTE system (e.g., when the CN 1424 is an EPC), the interface 1422 may be an X2 interface. The X2 interface may be defined between two or more base stations (e.g., two or more eNBs and the like) that connect to an EPC, and/or between two eNBs connecting to the EPC.

The RAN 1406 is shown to be communicatively coupled to the CN 1424. The CN 1424 may comprise one or more network elements 1426, which are configured to offer various data and telecommunications services to customers/subscribers (e.g., users of UE 1402 and UE 1404) who are connected to the CN 1424 via the RAN 1406. The components of the CN 1424 may be implemented in one physical device or separate physical devices including components to read and execute instructions from a machine-readable or computer-readable medium (e.g., a non-transitory machine-readable storage medium). For example, the components of the CN 1424 may be implemented in one or more processors and/or one or more associated memories.

In embodiments, the CN 1424 may be an EPC, and the RAN 1406 may be connected with the CN 1424 via an S1 interface 1428. In embodiments, the S1 interface 1428 may be split into two parts, an S1 user plane (S1-U) interface, which carries traffic data between the base station 1412, base station 1414, and a serving gateway (S-GW), and the S1-MME interface, which is a signaling interface between the base station 1412 and/or the base station 1414 and mobility management entities (MMEs).

In embodiments, the CN 1424 may be a 5GC, and the RAN 1406 may be connected with the CN 1424 via an NG interface 1428. In embodiments, the NG interface 1428 may be split into two parts, an NG user plane (NG-U) interface, which carries traffic data between the base station 1412 and/or base station 1414 and a user plane function (UPF), and the S1 control plane (NG-C) interface, which is a signaling interface between the base station 1412 and/or the base station 1414 and access and mobility management functions (AMFs).

Generally, an application server 1430 may be an element offering applications that use internet protocol (IP) bearer resources with the CN 1424 (e.g., packet switched data services). The application server 1430 can also be configured to support one or more communication services (e.g., VoIP sessions, group communication sessions, etc.) for the UE 1402 and UE 1404 via the CN 1424. The application server 1430 may communicate with the CN 1424 through an IP communications interface 1432.

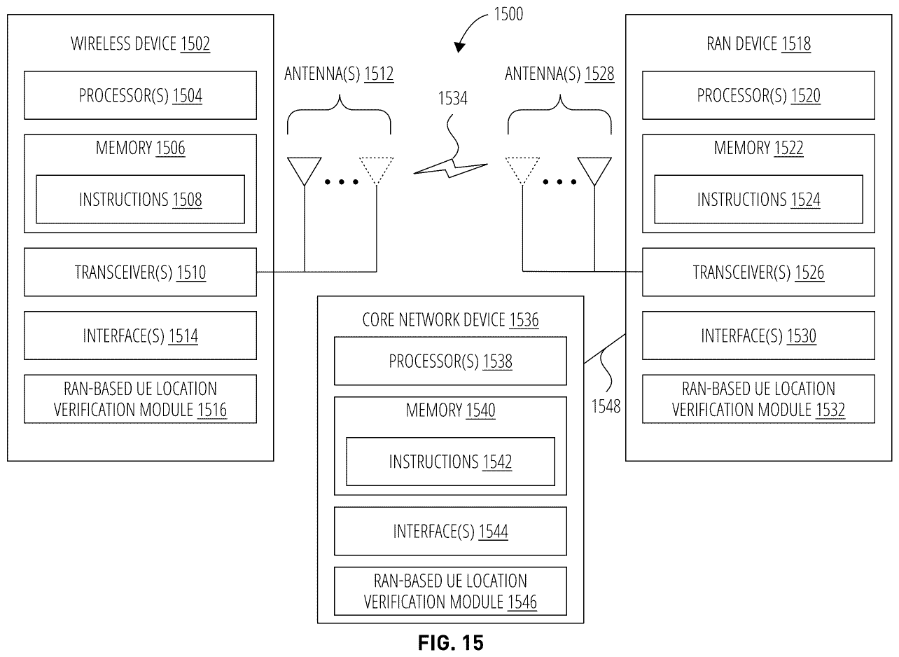

FIG. 15 illustrates a system 1500 for performing signaling 1534 between a wireless device 1502 and a RAN device 1518 connected to a core network of a CN device 1536, according to embodiments herein. The system 1500 may be a portion of a wireless communications system as herein described. The wireless device 1502 may be, for example, a UE of a wireless communication system. The RAN device 1518 may be, for example, a base station (e.g., an eNB or a gNB) of a wireless communication system that is a terrestrial base station. In the case of a RAN device 1518 that is a terrestrial base station, the RAN device 1518 may be in communication with a payload of a satellite that directly provides radio access connectivity to a UE, in the manner described herein. The CN device 1536 may be one or more devices making up a CN, as described herein.

The wireless device 1502 may include one or more processor(s) 1504. The processor(s) 1504 may execute instructions such that various operations of the wireless device 1502 are performed, as described herein. The processor(s) 1504 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1502 may include a memory 1506. The memory 1506 may be a non-transitory computer-readable storage medium that stores instructions 1508 (which may include, for example, the instructions being executed by the processor(s) 1504). The instructions 1508 may also be referred to as program code or a computer program. The memory 1506 may also store data used by, and results computed by, the processor(s) 1504.

The wireless device 1502 may include one or more transceiver(s) 1510 that may include RF transmitter and/or receiver circuitry that use the antenna(s) 1512 of the wireless device 1502 to facilitate signaling (e.g., the signaling 1534) to and/or from the wireless device 1502 with other devices (e.g., the RAN device 1518) according to corresponding RATs. In some embodiments, the antenna(s) 1512 may include a moving parabolic antenna, an omni-directional phased-array antenna, or some other antenna suitable for communication with a payload on a satellite, (e.g., as described above in relation to the UE 108 of FIG. 1).

In an NTN case, the network device signaling 1534 may occur on a service link between the wireless device 1502 and a payload on a satellite and a feeder link between the payload of the satellite and the RAN device 1518 (e.g., as described in relation to FIG. 1).

The wireless device 1502 may include one or more antenna(s) 1512 (e.g., one, two, four, or more). For embodiments with multiple antenna(s) 1512, the wireless device 1502 may leverage the spatial diversity of such multiple antenna(s) 1512 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1502 may be accomplished according to precoding (or digital beamforming) that is applied at the wireless device 1502 that multiplexes the data streams across the antenna(s) 1512 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1502 may implement analog beamforming techniques, whereby phases of the signals sent by the antenna(s) 1512 are relatively adjusted such that the (joint) transmission of the antenna(s) 1512 can be directed (this is sometimes referred to as beam steering).

The wireless device 1502 may include one or more interface(s) 1514. The interface(s) 1514 may be used to provide input to or output from the wireless device 1502. For example, a wireless device 1502 that is a UE may include interface(s) 1514 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1510/antenna(s) 1512 already described) that allow for communication between the UE and other devices and may operate according to known protocols (e.g., Wi-Fi®, Bluetooth®, and the like).

The wireless device 1502 may include a RAN-based UE location verification module 1516. The RAN-based UE location verification module 1516 may be implemented via hardware, software, or combinations thereof. For example, the RAN-based UE location verification module 1516 may be implemented as a processor, circuit, and/or instructions 1508 stored in the memory 1506 and executed by the processor(s) 1504. In some examples, the RAN-based UE location verification module 1516 may be integrated within the processor(s) 1504 and/or the transceiver(s) 1510. For example, the RAN-based UE location verification module 1516 may be implemented by a combination of software components (e.g., executed by a DSP or a general processor) and hardware components (e.g., logic gates and circuitry) within the processor(s) 1504 or the transceiver(s) 1510.

The RAN-based UE location verification module 1516 may be used for various aspects of the present disclosure, for example, aspects of FIG. 1 through FIG. 15. The RAN-based UE location verification module 1516 is configured to, for example, provide a reported location of the UE and a measurement report jointly when so instructed (e.g., by a RAN device 1518 that is a base station), etc.

The RAN device 1518 may include one or more processor(s) 1520. The processor(s) 1520 may execute instructions such that various operations of the RAN device 1518 are performed, as described herein. The processor(s) 1504 may include one or more baseband processors implemented using, for example, a CPU, a DSP, an ASIC, a controller, an FPGA device, another hardware device, a firmware device, or any combination thereof configured to perform the operations described herein.

The RAN device 1518 may include a memory 1522. The memory 1522 may be a non-transitory computer-readable storage medium that stores instructions 1524 (which may include, for example, the instructions being executed by the processor(s) 1520). The instructions 1524 may also be referred to as program code or a computer program. The memory 1522 may also store data used by, and results computed by, the processor(s) 1520.

The RAN device 1518 may include one or more transceiver(s) 1526 that may include RF transmitter and/or receiver circuitry that use the antenna(s) 1528 of the RAN device 1518 to facilitate signaling (e.g., the signaling 1534) to and/or from the RAN device 1518 with other devices (e.g., the wireless device 1502) according to corresponding RATs.

The RAN device 1518 may include one or more antenna(s) 1528 (e.g., one, two, four, or more). In embodiments having multiple antenna(s) 1528, the RAN device 1518 may perform MIMO, digital beamforming, analog beamforming, beam steering, etc., as has been described.

In an NTN case, the transceiver(s) 1526 and the antenna(s) 1528 may alternatively be present on a payload of a satellite associated with the base station.

The RAN device 1518 may include one or more interface(s) 1530. The interface(s) 1530 may be used to provide input to or output from the RAN device 1518. For example, a RAN device 1518 that is a base station may include interface(s) 1530 made up of transmitters, receivers, and other circuitry (e.g., other than the transceiver(s) 1526/antenna(s) 1528 already described) that enables the base station to communicate with other equipment in a CN, and/or that enables the base station to communicate with external networks, computers, databases, and the like for purposes of operations, administration, and maintenance of the base station or other equipment operably connected thereto.

The RAN device 1518 may include a RAN-based UE location verification module 1532. The RAN-based UE location verification module 1532 may be implemented via hardware, software, or combinations thereof. For example, the RAN-based UE location verification module 1532 may be implemented as a processor, circuit, and/or instructions 1524 stored in the memory 1522 and executed by the processor(s) 1520. In some examples, the RAN-based UE location verification module 1532 may be integrated within the processor(s) 1520 and/or the transceiver(s) 1526. For example, the RAN-based UE location verification module 1532 may be implemented by a combination of software components (e.g., executed by a DSP or a general processor) and hardware components (e.g., logic gates and circuitry) within the processor(s) 1520 or the transceiver(s) 1526.

The RAN-based UE location verification module 1532 may be used for various aspects of the present disclosure, for example, aspects of FIG. 1 through FIG. 13. The RAN-based UE location verification module 1532 is configured to, for example, perform RAN-based UE location verification mechanisms as these have been described herein with/for a wireless device 1502 that is a UE, etc.

The RAN device 1518 may communicate with the CN device 1536 via the interface 1548, which may be analogous to the interface 1428 of FIG. 14 (e.g., may be an S1 and/or NG interface, either of which may be split into user plane and control plane parts).

The CN device 1536 may include one or more processor(s) 1538. The processor(s) 1538 may execute instructions such that various operations of the CN device 1536 are performed, as described herein. The processor(s) 1538 may include one or more baseband processors implemented using, for example, a CPU, a DSP, an ASIC, a controller, an FPGA device, another hardware device, a firmware device, or any combination thereof configured to perform the operations described herein.

The CN device 1536 may include a memory 1540. The memory 1540 may be a non-transitory computer-readable storage medium that stores instructions 1542 (which may include, for example, the instructions being executed by the processor(s) 1538). The instructions 1542 may also be referred to as program code or a computer program. The memory 1540 may also store data used by, and results computed by, the processor(s) 1538.

The CN device 1536 may include one or more interface(s) 1544. The interface(s) 1544 may be used to provide input to or output from the CN device 1536. For example, a CN device 1536 may include interface(s) 1530 made up of transmitters, receivers, and other circuitry that enables the CN device 1536 to communicate with other equipment in the CN, and/or that enables the CN device 1536 to communicate with external networks, computers, databases, and the like for purposes of operations, administration, and maintenance of the CN device 1536 or other equipment operably connected thereto.

The CN device 1536 may include a RAN-based UE location verification module 1546. The RAN-based UE location verification module 1546 may be implemented via hardware, software, or combinations thereof. For example, the RAN-based UE location verification module 1546 may be implemented as a processor, circuit, and/or instructions 1542 stored in the memory 1540 and executed by the processor(s) 1538. In some examples, the RAN-based UE location verification module 1546 may be integrated within the processor(s) 1538. For example, the RAN-based UE location verification module 1546 may be implemented by a combination of software components (e.g., executed by a DSP or a general processor) and hardware components (e.g., logic gates and circuitry) within the processor(s) 1538.

The RAN-based UE location verification module 1546 may be used for various aspects of the present disclosure, for example, aspects of FIG. 1 through FIG. 13. The RAN-based UE location verification module 1546 is configured to, for example, instruct a RAN device 1518 that is a base station to perform RAN-based UE location verification mechanisms for a wireless device 1502 that is a UE, to perform a logging of results provided by the RAN device 1518 that is the base station, etc.

Embodiments contemplated herein include an apparatus comprising means to perform one or more elements of the method 1100. This apparatus may be, for example, an apparatus of a UE (such as a wireless device 1502 that is a UE, as described herein).

Embodiments contemplated herein include one or more non-transitory computer-readable media comprising instructions to cause an electronic device, upon execution of the instructions by one or more processors of the electronic device, to perform one or more elements of the method 1100. This non-transitory computer-readable media may be, for example, a memory of a UE (such as a memory 1506 of a wireless device 1502 that is a UE, as described herein).

Embodiments contemplated herein include an apparatus comprising logic, modules, or circuitry to perform one or more elements of the method 1100. This apparatus may be, for example, an apparatus of a UE (such as a wireless device 1502 that is a UE, as described herein).

Embodiments contemplated herein include an apparatus comprising: one or more processors and one or more computer-readable media comprising instructions that, when executed by the one or more processors, cause the one or more processors to perform one or more elements of the method 1100. This apparatus may be, for example, an apparatus of a UE (such as a wireless device 1502 that is a UE, as described herein).

Embodiments contemplated herein include a signal as described in or related to one or more elements of the method 1100.

Embodiments contemplated herein include a computer program or computer program product comprising instructions, wherein execution of the program by a processor is to cause the processor to carry out one or more elements of the method 1100. The processor may be a processor of a UE (such as a processor(s) 1504 of a wireless device 1502 that is a UE, as described herein). These instructions may be, for example, located in the processor and/or on a memory of the UE (such as a memory 1506 of a wireless device 1502 that is a UE, as described herein).

Embodiments contemplated herein include an apparatus comprising means to perform one or more elements of any of method 700, method 1000, and/or method 1300. This apparatus may be, for example, an apparatus of a base station (such as a RAN device 1518 that is a base station, as described herein).

Embodiments contemplated herein include one or more non-transitory computer-readable media comprising instructions to cause an electronic device, upon execution of the instructions by one or more processors of the electronic device, to perform one or more elements of any of method 700, method 1000, and/or method 1300. This non-transitory computer-readable media may be, for example, a memory of a base station (such as a memory 1522 of a RAN device 1518 that is a base station, as described herein).

Embodiments contemplated herein include an apparatus comprising logic, modules, or circuitry to perform one or more elements of any of method 700, method 1000, and/or method 1300. This apparatus may be, for example, an apparatus of a base station (such as a RAN device 1518 that is a base station, as described herein).

Embodiments contemplated herein include an apparatus comprising: one or more processors and one or more computer-readable media comprising instructions that, when executed by the one or more processors, cause the one or more processors to perform one or more elements of any of method 700, method 1000, and/or method 1300. This apparatus may be, for example, an apparatus of a base station (such as a RAN device 1518 that is a base station, as described herein).

Embodiments contemplated herein include a signal as described in or related to one or more elements of any of method 700, method 1000, and/or method 1300.

Embodiments contemplated herein include a computer program or computer program product comprising instructions, wherein execution of the program by a processing element is to cause the processing element to carry out one or more elements of any of method 700, method 1000, and/or method 1300. The processor may be a processor of a base station (such as a processor(s) 1520 of a RAN device 1518 that is a base station, as described herein). These instructions may be, for example, located in the processor and/or on a memory of the base station (such as a memory 1522 of a RAN device 1518 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems, or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a base station, comprising:
receiving, from a user equipment (UE), via a non-terrestrial network (NTN) payload operating a serving cell of the base station, a reported location indicating that the UE is located in a geographical area of the serving cell corresponding to a beam used by the NTN payload;
performing verification on the reported location by:
sending, to the UE, via the NTN payload, one of a radio resource control (RRC) configuration message and a scheduling information message on the beam; and
determining, based on a failure to receive a response from the UE to the one of the RRC configuration message and the scheduling information message, that the UE is not located in the geographical area as indicated by the reported location; and
restricting an operation of the UE with a network service for the geographical area based on the determination that the UE is not located in the geographical area.

2. The method of claim 1, further comprising indicating, to a core network (CN), that the UE is not located in the geographical area.

3. The method of claim 1, further comprising logging, at the base station, that the UE is not located in the geographical area.

4. The method of claim 1, further comprising receiving an instruction to perform the verification on the reported location.

5. The method of claim 4, wherein the instruction is received from a core network (CN).

6. The method of claim 4, wherein the instruction is received as part of an operations, administration and maintenance (OAM) procedure performed by an operator of the base station.

7. The method of claim 1, wherein the verification is performed on the reported location in response to a detection of a triggering event.

8. The method of claim 1, wherein the verification is performed on the reported location in response to a determination that the UE is of a type for which the verification on the reported location is to be performed.

9. A method of a base station, comprising:
receiving, from a user equipment (UE), via a non-terrestrial network (NTN) payload operating a serving cell of the base station, a reported location indicating that the UE is located in a geographical area of the serving cell;
performing verification on the reported location by:
receiving, from the UE, via the NTN payload, a measurement report indicating a preferred beam of the NTN payload for the UE, wherein the preferred beam does not correspond to the geographical area; and
determining, based on a determination that the preferred beam does not correspond to the geographical area, that the UE is not located in the geographical area; and
restricting an operation of the UE with a network service for the geographical area based on the determination that the UE is not located in the geographical area as indicated by the reported location.

10. The method of claim 9, further comprising sending, to the UE, via the NTN payload, a location reporting request indicating that the reported location and the measurement report be sent jointly by the UE, and wherein the reported location and the measurement report are received jointly at the base station in response to the location reporting request.

11. The method of claim 9, further comprising indicating, to a core network (CN), that the UE is not located in the geographical area.

12. The method of claim 9, further comprising logging, at the base station, that the UE is not located in the geographical area.

13. The method of claim 9, further comprising receiving an instruction to perform the verification on the reported location.

14. The method of claim 13, wherein the instruction is received from a core network (CN).

15. The method of claim 13, wherein the instruction is received as part of an operations, administration and maintenance (OAM) procedure performed by an operator of the base station.

16. The method of claim 9, wherein the verification is performed on the reported location in response to a detection of a triggering event.

17. The method of claim 9, wherein the verification is performed on the reported location in response to a determination that the UE is of a type for which the verification on the reported location is to be performed.

18. A method of a user equipment (UE), comprising:
receiving, from a base station, via a non-terrestrial network (NTN) payload, a location reporting request indicating that a reported location of the UE and a measurement report be sent jointly by the UE;
determining a current location of the UE to be the reported location of the UE;
generating a measurement report using one or more reference signals sent to the UE by the NTN payload; and
sending, to the base station, the reported location of the UE and the measurement report jointly in response to the location reporting request.

19-30. (canceled)
